(19) United States
(12) Patent Application Publication
(10) Pub. No.: US 2015/0061473 A1
(43) Pub. Date: Mar. 5, 2015

(54) DAUGHTER CIRCUIT BOARD OF ELECTRONICALLY COMMUTATED MOTOR HAVING INTERFACE SIGNAL CONVERSION FUNCTION

(71) Applicant: Zhongshan Broad-Ocean Motor Co., Ltd., Zhongshan (CN)

(72) Inventors: Yong ZHAO, Zhongshan (CN); Xiansheng ZHANG, Zhongshan (CN)

(21) Appl. No.: 14/534,202

(22) Filed: Nov. 6, 2014

Related U.S. Application Data
(63) Continuation-in-part of application No. PCT/CN2013/085747, filed on Oct. 23, 2013.

(30) Foreign Application Priority Data
Jan. 31, 2013 (CN) 201320061394.2

(51) Int. Cl. H02K 11/00

(52) U.S. Cl. CPC H02K 11/0094
USPC 310/68 R

(57) ABSTRACT

A daughter circuit board of an electronically commutated motor. The daughter circuit board has the function of interface signal conversion and can be plugged into a mother circuit board of a motor controller to match with an interface signal of a user end control system. The daughter circuit board includes an interface unit circuit. The interface unit circuit includes an RS485 interface circuit. The interface unit circuit is integrated on the daughter circuit board.

### CROSS-REFERENCE TO RELATED APPLICATIONS

This application is a continuation-in-part of International Patent Application No. PCT/CN2013/085747 with an international filing date of Oct. 23, 2013, designating the United States, now pending, and further claims priority benefits to Chinese Patent Application No. 201320061394.2 filed Jan. 31, 2013. The contents of all of the aforementioned applications, including any intervening amendments thereto, are incorporated herein by reference.

### BACKGROUND OF THE INVENTION

1. Field of the Invention

The invention relates to a daughter circuit board of an electronically commutated motor (ECM) for interface signal conversion.

2. Description of the Related Art

As shown in FIGS. 1-2, a typical electronically commutated drive motor includes a motor body and a motor controller. The motor body includes a stator part and a rotor part. The motor controller is not just required to match with the motor body but is also required to match with a specific application system, that is, a user end control system, because different user end control systems match with different control signals. For example, although the air conditioning control system and the washing machine control system are both user end control systems, control signals of the two systems are quite different.

A typical method in the art is to develop a motor and a motor controller for every user end control system, which unfortunately results in the following problems: 1) a large quantity of motor types are produced by motor manufacturers, which is difficult to manage and standardize; 2) much time and money invested in the research are wasted, every new user end control system demands a newly developed motor, thereby increasing the production cost; 3) new production procedures and certification cost are required for new designs, thereby increasing the investment; and 4) the application range of the motor is very narrow, which limits the large-scale application.

To solve the above technical problem, a plurality of motor controllers including mother-daughter circuit boards appears. Main functional circuits are disposed on the mother circuit board of the motor controller, and a plurality of interface unit circuits and identify circuits are disposed on a plurality of daughter circuits. One of the daughter circuits is connected to the mother circuit. The identify circuit of the daughter circuit sends a signal to a microprocessor unit of the mother circuit board, and the microprocessor unit automatically configure I/O port types of the daughter circuit board, so that the motor controller can be applied to different occasions by replacing different daughter circuit boards, thereby broadening the application range thereof, and the types of the motor can be reduced by the motor manufacturers, thereby being convenient for management, decreasing the development investment and the production cost, shortening the development cycle, simplifying the production procedure, and improving the efficiency.

Specific technical solution is shown in FIGS. 3-5, the motor controller includes the microprocessor unit, a signal interface unit, and an identify circuit. The microprocessor is arranged on the mother circuit board. The signal interface unit and the identify circuit are arranged on the daughter circuit board. The daughter circuit board and the mother circuit board form electric connection. The identify circuit inputs an identify signal into the microprocessor, and the microprocessor automatically configures each I/O port of the signal interface unit according to the identify signal. Different kinds of signal interface unit matches with different signals output by the identify circuit, so that a plurality of daughter circuit boards is formed. An output end of a microprocessor unit is connected to a power inverter unit, and an output end of a rotor position detection unit is connected to an input end of the microprocessor. The power inverter unit and the rotor position detection unit are all arranged on the mother circuit board. A power circuit and an analog detection unit are also arranged on the mother circuit board. The analog detection unit primarily detects analog information relating to a bus current, a bus voltage, a phase current, and an NTC of the mother circuit board. The power circuit supplies power to each circuit. The microprocessor unit is a CPU, a microcontroller MCU, or a digital signal processor DSP. The mother circuit board is provided with a connector port 3, and the connector port 3 is provided with eleven lug plates. The daughter circuit boards can be several. The eleven lug plates of the connector ports 3 are E, N, L, M1, M2, M3, M4, M5, M6, M7, M8. The lug plates are defined according to the following standard: E, N, L are three lines power inputs, and M1, M2, M3, M4, M5, M6, M7, and M8 are interface signals input from the user end control system to the daughter circuit board. The mother circuit board is provided with a slot 1, and the daughter circuit board is provided with a plug connector 2. The plug connector 2 is nested within the slot 1 so as to realize an electric connection between the daughter circuit board and the mother circuit board.

Drawbacks in practical application are as follows: 1) a large number of pathways exist in the interface signals, which results in complex circuit structure and high production costs; 2) high voltage signal control exists in the interface signal, and multiple-path of electrical isolation is required between the daughter circuit board and the mother circuit board, thereby resulting in complex circuit and high production cost; and 3) the interface signal has many types, which indirectly results in complex circuit structure.

### SUMMARY OF THE INVENTION

In view of the above-described problems, it is one objective of the invention to provide a daughter circuit board of an electronically commutated motor for interface signal conversion so as to decrease the number and type of the interface signals, simplify the circuit structure, lower the production cost, and further simplify the interface circuit by adopting the low voltage digital signal communication.

To achieve the above objective, in accordance with one embodiment of the invention, there is provided a daughter circuit board of an electronically commutated motor for interface signal conversion. The daughter circuit board is used to be plugged into a mother circuit board of a motor controller for matching with an interface signal of a user end control system. The daughter circuit board comprises an interface unit circuit. The interface unit circuit comprises an RS485 interface circuit. The interface unit circuit is integrated on the daughter circuit board.

In a class of this embodiment, the RS485 interface circuit is connected to a microprocessor unit of the mother circuit board of the motor controller. The user end control system communicates with the microprocessor unit of the mother circuit board of the motor controller via the RS485 interface circuit.

In a class of this embodiment, the daughter circuit board comprises four ports for connecting to the user end control system. The four ports comprise: a user end power port, a user end ground port, a user end inphase input/output port, and a user end inverting input/output port. The user end power port supplies power to the RS485 interface circuit. The user end ground port is a common ground terminal of the RS495 interface circuit. The user end inphase input/output port functions in outputting or inputting an inphase signal. The user end inverting input/output port functions in outputting or inputting an inverting signal.

In a class of this embodiment, the interface unit circuit further comprises an identify circuit. An output end of the identify circuit is connected to an input end of the microprocessor unit disposed on the mother circuit board.

In a class of this embodiment, the daughter circuit board comprises five ports for connecting to the mother circuit board. The five ports comprise: a mother circuit board power port, a mother circuit board ground port, an identify port, a communication transmitting end, and a communication receiving end. The mother circuit board power port supplies power to the RS485 interface circuit. The mother circuit board ground port is a common ground terminal of the RS485 interface circuit. The identify port BSEL provides an identification signal relating to a daughter circuit board type to the mother circuit board. The communication transmitting end receives a control signal from the mother circuit board for controlling communication. The communication receiving end realizes mutual data transmission.

In a class of this embodiment, the identify circuit comprises a first resistor and a second resistor connected in series. Two ends of the identify circuit are connected to a power supply and the ground, respectively. An identify signal relating to a daughter circuit board type is output from between the first resistor and the second resistor.

Advantages according to embodiments of the invention are summarized as follows:

1) The daughter circuit board of the electronically commutated motor for interface signal conversion is used to be plugged into the mother circuit board of the motor controller for matching with the interface signal of the user end control system. The daughter circuit board comprises the interface unit circuit integrated on the daughter circuit board. The interface unit circuit comprises the RS485 interface circuit. Thus, the number and type of the interface signals are decreased, the circuit structure is simplified, and the production cost is lowered. Furthermore, the low voltage digital signal communication is adopted, thereby further simplifying the interface circuit.

2) The daughter circuit board is provided with four ports for connecting to the user end control system. The four ports are the user end power port, the user end ground port, the user end inphase input/output port, and the user end inverting input/output port. The number of the interface ports of the original daughter circuit boards is decreased by ½.

3) The daughter circuit board is provided with five ports for connecting to the mother circuit board. The five ports comprise: the mother circuit board power port, the mother circuit board ground port, the identify port, the communication transmitting end, and the communication receiving end. The mother circuit board power port supplies power to the RS485 interface circuit. The mother circuit board ground port is the common ground terminal of the RS485 interface circuit. The identify port BSEL provides the identification signal relating to the daughter circuit board type to the mother circuit board. The communication transmitting end receives the control signal from the mother circuit board for controlling communication. The communication receiving end realizes mutual data transmission. Thus, the number of the connecting ports is largely decreased and the circuit structure is simplified.

### BRIEF DESCRIPTION OF THE DRAWINGS

The invention is described hereinbelow with reference to the accompanying drawings, in which:

FIG. 1 is a wiring diagram between a conventional motor controller and a user end control system;

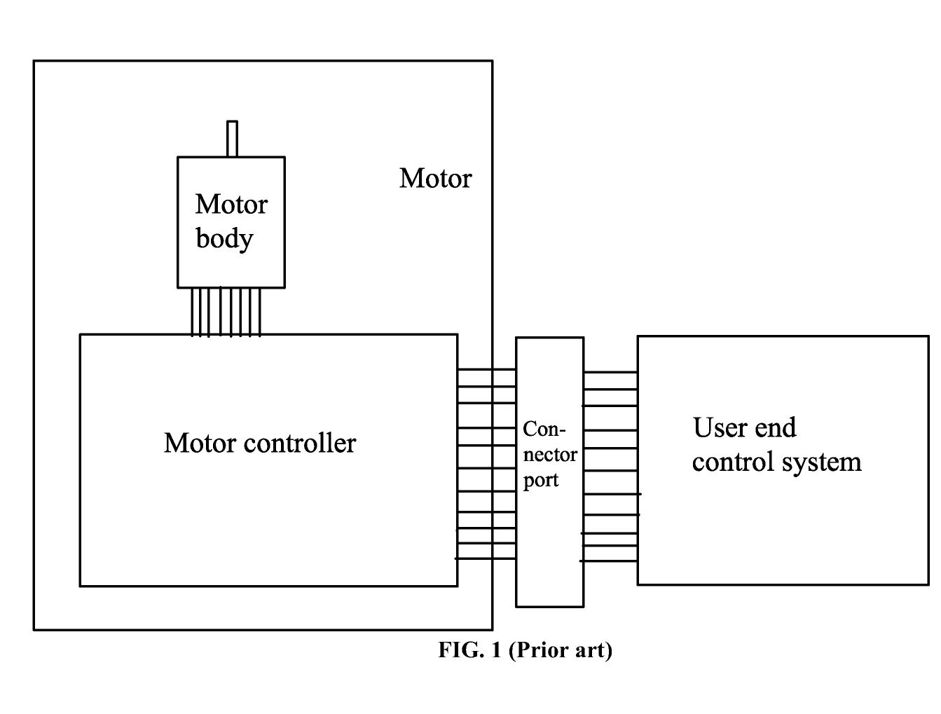

FIG. 2 is a block diagram of a conventional motor controller;

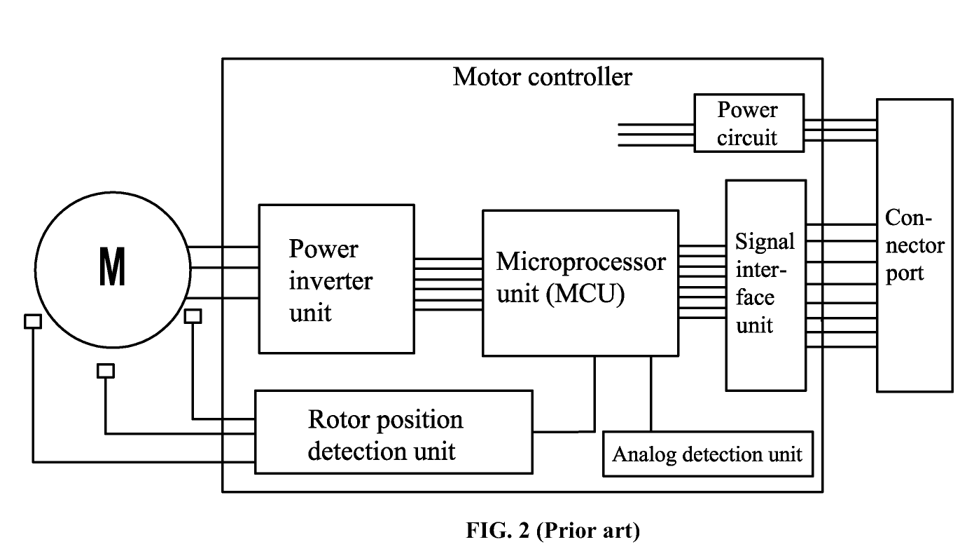

FIG. 3 is a schematic diagram of a conventional motor controller adopting daughter-mother circuit boards;

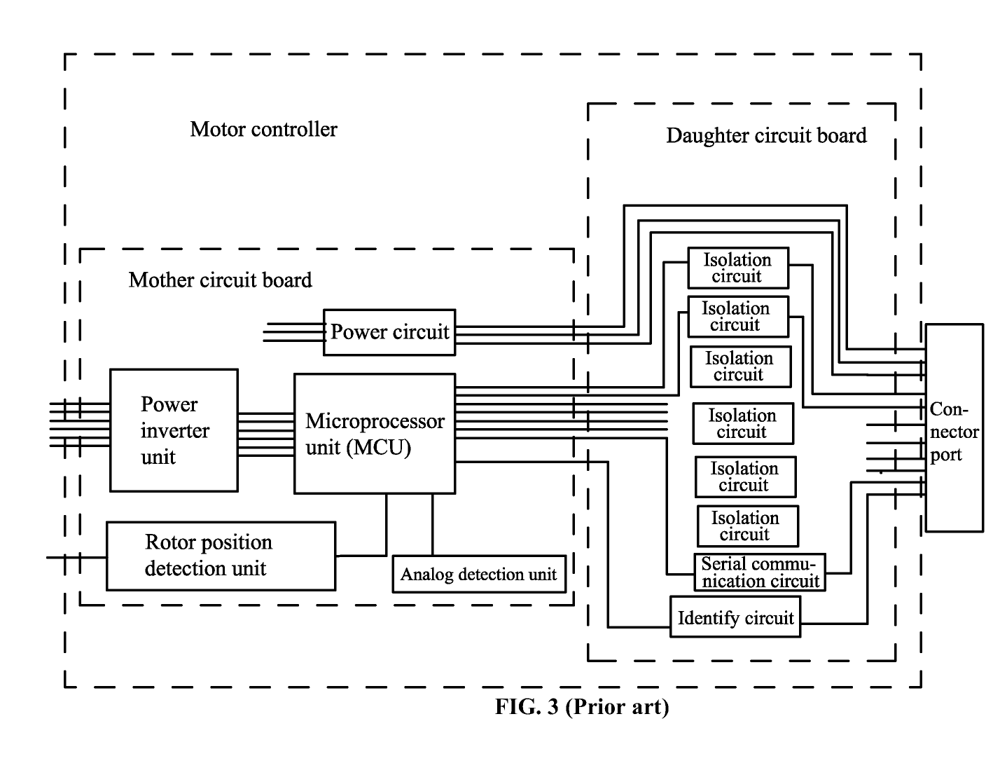

FIG. 4 is a schematic diagram of a mother circuit board of a conventional motor controller;

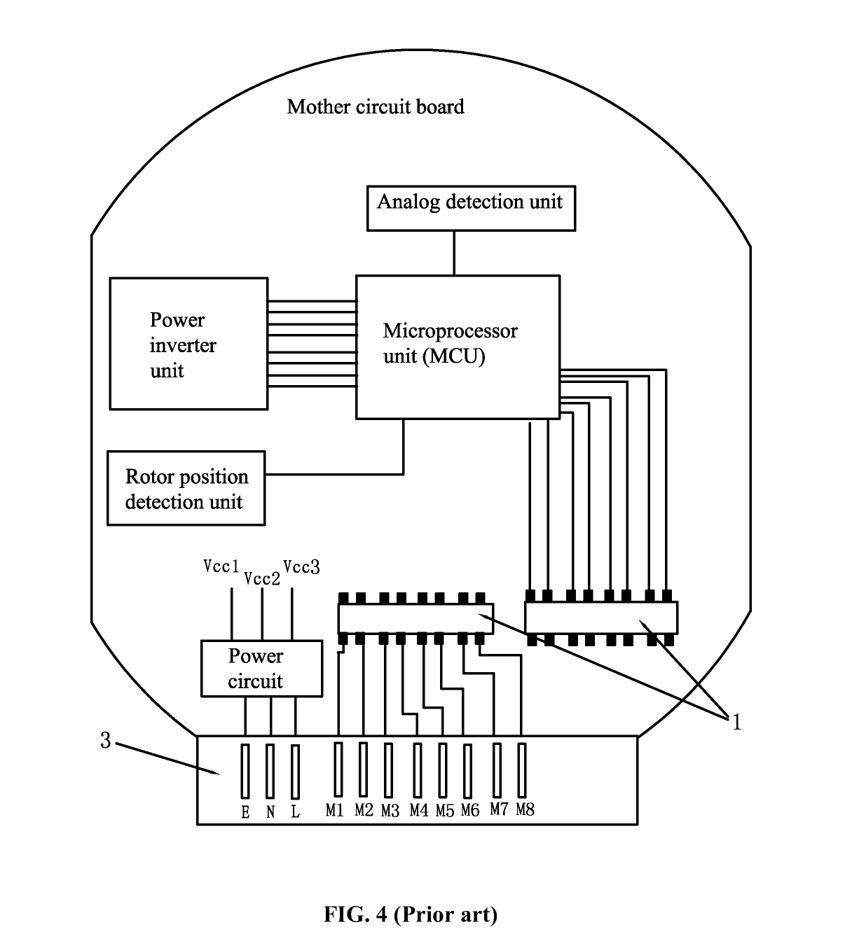

FIG. 5 is a schematic diagram of a daughter circuit board of a conventional motor controller;

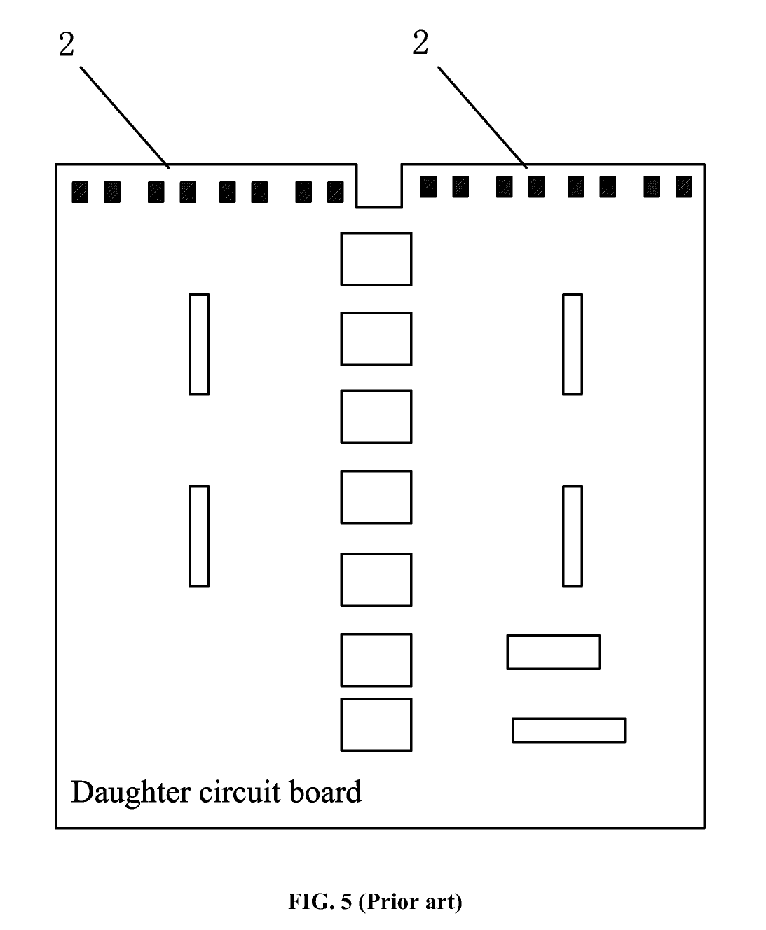

FIG. 6 is a circuit block diagram of a daughter circuit board of an electronically commutated motor for interface signal conversion in accordance with one embodiment of the invention; and

FIG. 7 is a circuit diagram of a daughter circuit board in accordance with one embodiment of the invention.

### DETAILED DESCRIPTION OF THE EMBODIMENTS

For further illustrating the invention, experiments detailing a daughter circuit board of an electronically commutated motor for interface signal conversion are described below. It should be noted that the following examples are intended to describe and not to limit the invention.

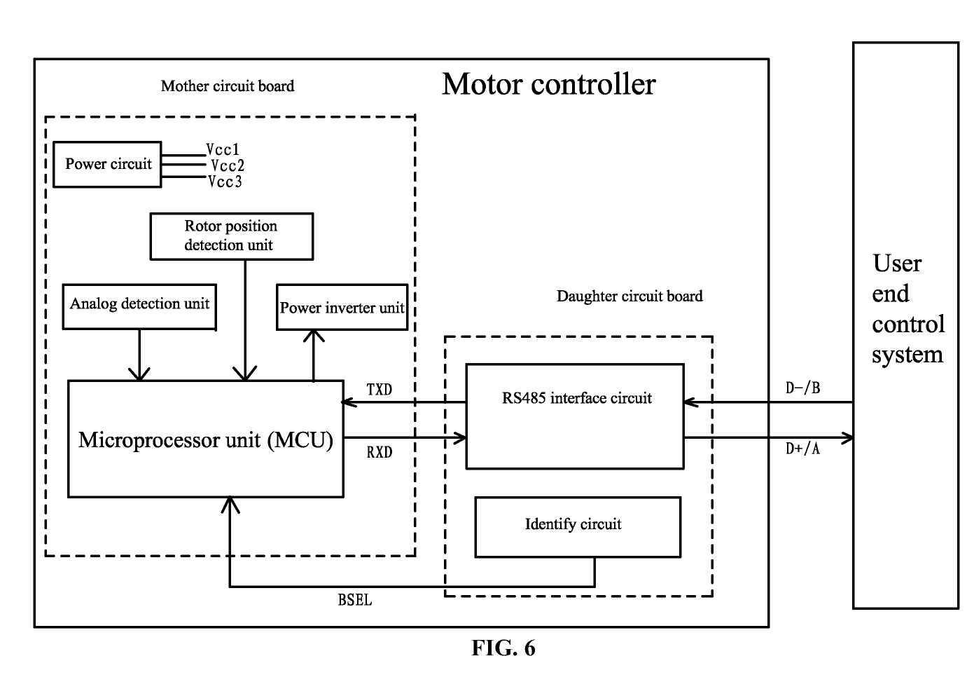

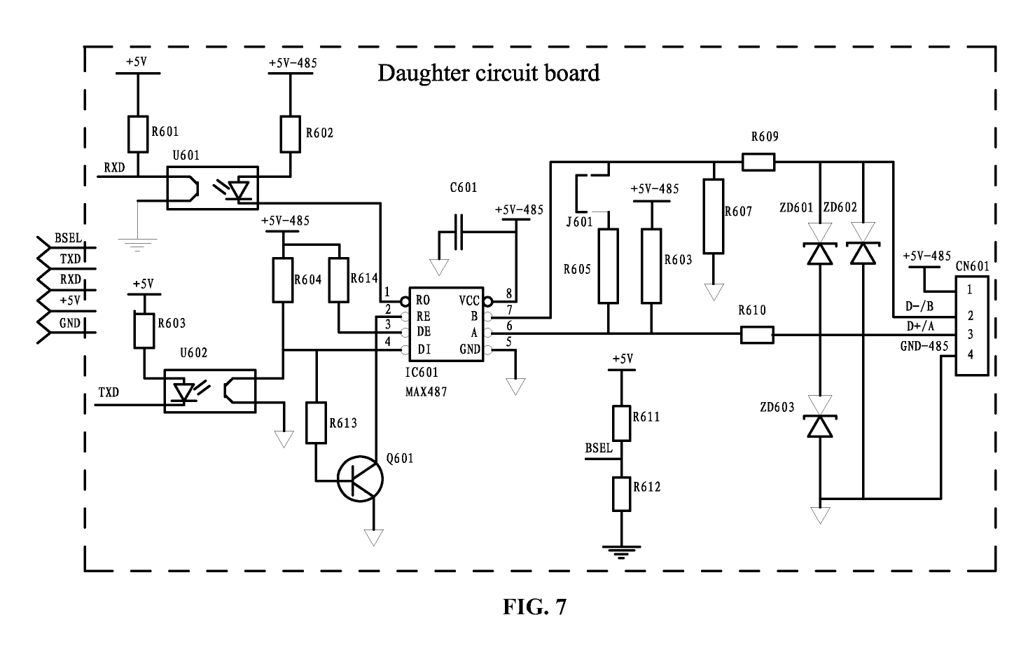

As shown in FIGS. 6-7, a daughter circuit board for converting an interface signal of an electronically commutated motor is used to be plugged into a mother circuit board of a motor controller for matching with an interface signal from a user end control system. The daughter circuit comprises an interface unit circuit integrated thereon. The interface unit circuit comprises an RS485 interface circuit. The RS485 interface circuit is connected to a microprocessor unit of the mother circuit board of the motor controller. The user end control system communicates with the microprocessor unit of the mother circuit board of the motor controller via the RS485 interface circuit.

The daughter circuit board is provided with four ports for connecting to the user end control system. The four ports comprise: a user end power port +5V-485, a user end ground port GND-485, a user end inphase input/output port D+/A, and a user end inverting input/output port D−/B. The user end power port +5V-485 supplies power to the RS485 interface circuit. The user end ground port GND-485 is a common ground terminal of the RS495 interface circuit. The user end inphase input/output port D+/A functions in outputting or inputting an inphase signal. The user end inverting input/output port D−/B functions in outputting or inputting an inverting signal.

The daughter circuit board is provided with five ports for connecting to the mother circuit board. The five ports comprise: a mother circuit board power port +5V, a mother circuit board ground port GND, an identify port BSEL, a communication transmitting end TXD, and a communication receiving end RXD. The mother circuit board power port +5V supplies power to the RS485 interface circuit. The mother circuit board ground port GND is a common ground terminal of the RS485 interface circuit. The identify port BSEL provides an identification signal relating to a daughter circuit board type to the mother circuit board. The communication transmitting end TXD receives a control signal from the mother circuit board for controlling communication. The communication receiving end RXD realizes mutual transmission of data.

The interface unit circuit further comprises an identify circuit. An output end of the identify circuit is connected to an input end of the microprocessor unit MCU of the mother circuit board. The identify circuit comprises a first resistor R611 and a second resistor R612 connected in series. Two ends of the identify circuit are connected to a power supply and the ground, respectively. The identify signal BSEL relating to a daughter circuit board type is output from between the first resistor R611 and the second resistor R612.

The RS485 comprises: a main chip IC601; optical couplers U601 and U602; resistors R601, R602, R603, R604, R605, R606, R607, R608, R609, R610, R611, R612, and R613; voltage stabilizers ZD601, ZD602, and ZD603; and a triode Q601. Connection relationships of the components are shown in FIG. 7. Base pins of RE and DE of the main chip IC601 communicate with a signal from the communication transmitting end TXD, so that the communication of the RS485 interface circuit is realized. Details of the communication are listed in the following logic table, in which, true value of the A-B pin and RO pin of the main chip IC601 and the communication receiving end RXD are listed.

| State | TXD | DE | RE | A-B | RO | RXD |
|---|---|---|---|---|---|---|
| State 1 | L | H (valid receive) | H (invalid transmission) | L | / | / |
| State 2 | H | L (invalid transmission) | L (valid receive) | H (default) | / | / |
| State 3 | H | L (invalid transmission) | L (valid receive) | >=+0.2 V | H | H |
| State 4 | H | L (invalid transmission) | L (valid receive) | <=−0.2 V | L | L |

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A daughter circuit board of an electronically commutated motor, the daughter circuit board being adapted to be plugged into a mother circuit board of a motor controller and to match with an interface signal of a user end control system, the daughter circuit board comprising an interface unit circuit, the interface unit circuit comprising an RS485 interface circuit; wherein the interface unit circuit is integrated on the daughter circuit board.

2. The daughter circuit board of claim 1, wherein
the RS485 interface circuit is connected to a microprocessor unit of the mother circuit board of the motor controller; and
the user end control system communicates with the microprocessor unit of the mother circuit board of the motor controller via the RS485 interface circuit.

3. The daughter circuit board of claim 1, wherein
the daughter circuit board comprises four ports for connecting to the user end control system;
the four ports comprise: a user end power port, a user end ground port, a user end inphase input/output port, and a user end inverting input/output port;
the user end power port supplies power to the RS485 interface circuit;
the user end ground port is a common ground terminal of the RS495 interface circuit;
the user end inphase input/output port functions in outputting or inputting an inphase signal; and
the user end inverting input/output port functions in outputting or inputting an inverting signal.

4. The daughter circuit board of claim 2, wherein
the daughter circuit board comprises four ports for connecting to the user end control system;
the four ports comprise: a user end power port, a user end ground port, a user end inphase input/output port, and a user end inverting input/output port;
the user end power port supplies power to the RS485 interface circuit;
the user end ground port is a common ground terminal of the RS495 interface circuit;
the user end inphase input/output port functions in outputting or inputting an inphase signal; and
the user end inverting input/output port functions in outputting or inputting an inverting signal.

5. The daughter circuit board of claim 3, wherein
the interface unit circuit further comprises an identify circuit; and
an output end of the identify circuit is connected to an input end of the microprocessor unit disposed on the mother circuit board.

6. The daughter circuit board of claim 4, wherein
the interface unit circuit further comprises an identify circuit; and
an output end of the identify circuit is connected to an input end of the microprocessor unit disposed on the mother circuit board.

7. The daughter circuit board of claim 5, wherein
the daughter circuit board comprises five ports for connecting to the mother circuit board;
the five ports comprise: a mother circuit board power port, a mother circuit board ground port, an identify port, a communication transmitting end, and a communication receiving end;
the mother circuit board power port supplies power to the RS485 interface circuit;
the mother circuit board ground port is a common ground terminal of the RS485 interface circuit;
the identify port BSEL provides an identify signal relating to a daughter circuit board type to the mother circuit board;
the communication transmitting end receives a control signal from the mother circuit board for controlling communication; and
the communication receiving end realizes mutual data transmission.

8. The daughter circuit board of claim 6, wherein
the daughter circuit board comprises five ports for connecting to the mother circuit board;
the five ports comprise: a mother circuit board power port, a mother circuit board ground port, an identify port, a communication transmitting end, and a communication receiving end;
the mother circuit board power port supplies power to the RS485 interface circuit;
the mother circuit board ground port is a common ground terminal of the RS485 interface circuit;
the identify port BSEL provides an identify signal relating to a daughter circuit board type to the mother circuit board;
the communication transmitting end receives a control signal from the mother circuit board for controlling communication; and
the communication receiving end realizes mutual data transmission.

9. The daughter circuit board of claim 3, wherein
the identify circuit comprises a first resistor (R611) and a second resistor (R612) connected in series;
two ends of the identify circuit are connected to a power supply and the ground, respectively; and
an identify signal (BSEL) relating to a daughter circuit board type is output from between the first resistor (R611) and the second resistor (R612).

10. The daughter circuit board of claim 4, wherein the identify circuit comprises a first resistor (R611) and a second resistor (R612) connected in series;
two ends of the identify circuit are connected to a power supply and the ground, respectively; and
an identify signal (BSEL) relating to a daughter circuit board type is output from between the first resistor (R611) and the second resistor (R612).
